(19) United States
(12) Patent Application Publication
(10) Pub. No.: US 2014/0304085 A1
(43) Pub. Date: Oct. 9, 2014

(54) METHOD AND APPARATUS FOR PROVIDING CONTEXT-BASED COUPON SHARING

(71) Applicants: Dong Liu, Beijing (CN); Jiang Li, Beijing (CN); Hao Yang, Montrose, NY (US); Zhanjiang Song, Beijing (CN)

(72) Inventors: Dong Liu, Beijing (CN); Jiang Li, Beijing (CN); Hao Yang, Montrose, NY (US); Zhanjiang Song, Beijing (CN)

(73) Assignee: Nokia Corporation, Espoo (FI)

(21) Appl. No.: 13/992,102

(22) PCT Filed: Dec. 10, 2010
(86) PCT No.: PCT/CN2010/079667

§ 371 Date: Feb. 3, 2014

(51) Int. Cl. G06Q 30/02

(52) U.S. Cl. CPC G06Q 30/0269
USPC 705/14.66

(57) ABSTRACT

An approach is provided for context-based coupon sharing. A coupon management platform receives a request specifying an exchange of one or more coupons. The request includes, at least in part, one or more attribute-condition pairs associated with the one or more coupons, one or more participants of the exchange, or a combination thereof. The coupon management plat form determines context data associated with a first user, at least one device associated with the first user, at least one second user, at least one other device associated with the at least one second user, or a combination thereof. The coupon management platform then causes, at least in part, processing of the one or more attribute-condition pairs, the context data, or a combination thereof for initiating the exchange between the first user and the at least one second user.

### BACKGROUND

Service providers and device manufacturers (e.g., wireless, cellular, etc.) are continually challenged to deliver value and convenience to consumers by, for example, providing compelling network services. Such services can often include shopping services and/or related marketing services. One area of interest has been the development of services that facilitate marketing promotions or discounts (e.g., coupons or other similar discount offers) provided from retailers to users. As a result, coupons and related discount offers have proliferated, making it difficult for users to discover coupons and discounts of interest. Accordingly, service providers and device manufacturers face significant technical challenges to enabling users to efficiently discover and share coupons.

### SOME EXAMPLE EMBODIMENTS

Therefore, there is a need for an approach for context-based coupon sharing.

According to one embodiment, a method comprises receiving a request specifying an exchange of one or more coupons. The request includes, at least in part, one or more attribute-condition pairs associated with the one or more coupons, one or more participants of the exchange, or a combination thereof. The method also comprises determining context data associated with a first user, at least one device associated with the first user, at least one second user, at least one other device associated with the at least one second user, or a combination thereof. The method further comprises causing, at least in part, processing of the one or more attribute-condition pairs, the context data, or a combination thereof for initiating the exchange between the first user and the at least one second user.

According to another embodiment, an apparatus comprising at least one processor, and at least one memory including computer program code, the at least one memory and the computer program code configured to, with the at least one processor, cause, at least in part, the apparatus to receive a request specifying an exchange of one or more coupons. The request including, at least in part, one or more attribute-condition pairs associated with the one or more coupons, one or more participants of the exchange, or a combination thereof. The apparatus is also caused to determine context data associated with a first user, at least one device associated with the first user, at least one second user, at least one other device associated with the at least one second user, or a combination thereof. The apparatus is further caused to process the one or more attribute-condition pairs, the context data, or a combination thereof for initiating the exchange between the first user and the at least one second user.

According to another embodiment, a computer-readable storage medium carrying one or more sequences of one or more instructions which, when executed by one or more processors, cause, at least in part, an apparatus to receive an input from a device specifying one or more criteria to receive a request specifying an exchange of one or more coupons. The request including, at least in part, one or more attribute-condition pairs associated with the one or more coupons, one or more participants of the exchange, or a combination thereof. The apparatus is also caused to determine context data associated with a first user, at least one device associated with the first user, at least one second user, at least one other device associated with the at least one second user, or a combination thereof. The apparatus is further caused to process the one or more attribute-condition pairs, the context data, or a combination thereof for initiating the exchange between the first user and the at least one second user.

According to another embodiment, an apparatus comprises means for receiving a request specifying an exchange of one or more coupons. The request including, at least in part, one or more attribute-condition pairs associated with the one or more coupons, one or more participants of the exchange, or a combination thereof. The apparatus also comprises means for determining context data associated with a first user, at least one device associated with the first user, at least one second user, at least one other device associated with the at least one second user, or a combination thereof. The apparatus further comprises means for causing, at least in part, processing of the one or more attribute-condition pairs, the context data, or a combination thereof for initiating the exchange between the first user and the at least one second user.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing context-based coupon sharing, according to one embodiment;

FIG. 2 is a diagram of the components of user equipment capable of context-based coupon sharing, according to one embodiment;

FIG. 3 is a diagram of the components of a coupon sharing platform 103, according to one embodiment;

FIG. 4 is a flowchart of a process for context-based coupon sharing, according to one embodiment;

FIGS. 5A-5D are diagrams of user interfaces utilized in the processes of FIGS. 3-4, according to various embodiments;

FIG. 6 is a diagram of hardware that can be used to implement an embodiment of the invention;

FIG. 7 is a diagram of a chip set that can be used to implement an embodiment of the invention; and

FIG. 8 is a diagram of a mobile terminal (e.g., handset) that can be used to implement an embodiment of the invention.

### DESCRIPTION OF SOME EMBODIMENTS

Examples of a method, apparatus, and computer program for coupon sharing among users based on context are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein the term “coupon” refers to a document, file, token, etc. that can be presented to receive a discount or rebate related to a transaction for goods and/or services. Although various embodiments are discussed with respect to sharing coupons among users, it is contemplated that the embodiments of the sharing process described herein are also applicable to any item that can be shared among users including, but not limited, to physical items, electronic items, goods, services, other items in commerce, and the like.

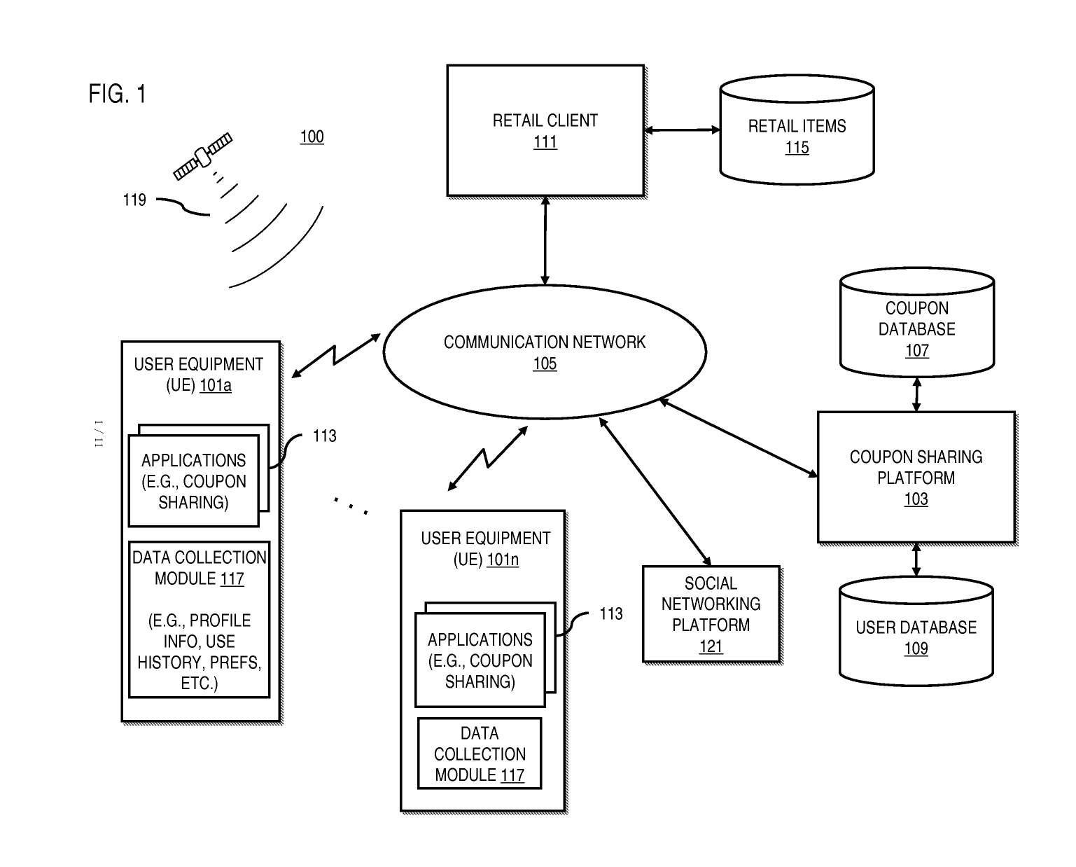

FIG. 1 is a diagram of a system capable of coupon sharing among users based on context, according to one embodiment. Traditionally, coupons often have limitations or other conditions with respect to, for instance, which merchants will accept the coupons, validity period, applicable products, etc. Thus, it is often the case that a user has a coupon that the user does not intend to use or cannot use (e.g., before the coupon becomes invalid). In this case, a user may want to share (e.g., with or without compensation) the unused or unwanted coupons with other consumers who can make use of the coupons. However, users who want to share or receive coupons often find it difficult to find each other to initiate the coupon exchange. Moreover, because coupons are often physical in nature (e.g., printed coupons), users who want to share coupons may also find it difficult to arrange for delivery. In some cases, trust concerns for sharing and receiving users can also discourage such delivery.

To address this problem, a system 100 of FIG. 1 introduces the capability to provide context-based coupon sharing. More specifically, the system 100 supports users in contributing and requesting coupons with specific context-based criteria. In one embodiment, the context-based criteria are specified as attribute-condition pairs where the attribute describes a particular characteristic of the coupon (e.g., a product, a discount amount, etc.) or one or more of the participating users (e.g., a location, membership in a social network, reputation, etc.), and the accompanying condition provides the criteria or values for evaluating the attribute (e.g., a condition that a discount is at least 25%, a condition that a receiving user be located with 0.5 miles of the sharing user, etc.). The system 100 then performs context-based matching of the coupon contribution/request according to the criteria (e.g., attribute-condition pairs). In one embodiment, the context-based matching is performed in real-time or substantially in real-time.

In one embodiment, on detection of a context-based match can result in sending a notification to the participating users when the match occurs. By way of example, the notification may be provided as a push notification. Then, according to the participating users' contexts, the system 100 can suggest or recommend how the coupon should be delivered or exchange (e.g., a mode of delivery, a time of delivery, a location of delivery, and the like). For example, for delivery of a physical coupon, the system 100 can suggest a meeting time and venue based, at least in part, on the context data associated with the users.

In another embodiment, the coupon sharing of the various embodiments described herein may be supplemented with a user experience and/or reputation rating system. For example, as users participate and successfully share coupons, their experience and reputation ratings can increase. The rating information can be made available to other users to address potential trust concerns when engaged in the sharing process. In this way, the system 100 provides users with additional opportunities to share coupons and promote sales for merchants offering the coupons.

In one embodiment, the participating users can define privacy policies for controlling access to or the visibility of all or a portion of their context information. For example, users may limit access to certain user profile or context information (e.g., gender, name, address, contact information, location, etc.) and/or restrict their access to only certain users (e.g., users who friends within a social network, members of the same social graph, etc.).

In yet another embodiment, the coupon sharing is facilitated by use of standard coupon templates for contributing and/or requesting coupon information. In this way, coupon information can be standardized for easier processing without using complex parsing and/or recognition of the coupon. In cases where no template is available for a particular coupon, the user may specify a new template or may provide the coupon information as free text.

As shown in FIG. 1, user equipment (UEs) 101a-101n (also collectively referred to as UEs 101) can connect to a coupon sharing platform 103 over a communication network 105 to utilize context-based coupon sharing. In this example, the UEs 101a-101n can be associated with one or more consumers searching for or otherwise accessing coupon information. Moreover, the coupon sharing platform 103 can retrieve coupon templates and/or coupon information from a coupon database 107 and user context information, profile information, preferences, etc. from the user database 109 for performing context-based matching to trigger coupon sharing. In other words, the databases 107 and 109 may be utilized to provide the context-based coupon sharing services to the UEs 101 and/or a retail client 111. In one embodiment, the UEs 101 can use an application 113 (e.g., a coupon application) to request and/or specify coupon information from other users.

In certain examples, the retail client 111 can be a UE 101 operated by a coupon provider (e.g., a retailer or seller) to share or otherwise specify coupon information. For example, a retail client 111 and/or UE 101 can be utilized to upload information about retail items 115 (e.g., retail items 115 associated with a retail store, other purchasable items such as goods and/or services, etc.) and related discount or coupon information to the coupon sharing platform 103. In this manner, coupon information and/or coupon templates, including coupon contributions and/or requests, can be transmitted to the coupon database 107 of the coupon sharing platform 103. In certain embodiments, the coupon information and/or templates may be defined and/or stored locally by the retail client 111 and/or UE 101 in, for instance, the retail items database 115.

In one embodiment, the discount database 107 may include information about one or more items (e.g., retail items) and associated coupon information. For example, the item database 109 may include categorical information associated with the items (e.g., products, services, etc.) The categorical information may be stored in a data structure (e.g., a tree) and include one or more subcategories. Further, the item database 109 can include a description of any discounts, coupons, promotions, etc. associated with one or more items of the database.

In another embodiment, profile information, discount use history, preferences, discount criteria, etc. as well as context information about a user participating in coupon sharing, the UE 101, or a combination thereof can be collected and monitored at the coupon sharing platform 103 or the UE 101. In certain embodiments, an application 113 on the UE 101 can monitor the information (e.g., context data, user preferences, user criteria, user history, etc.) associated with a data collection module 117 of the UE 101. For example, the data collection module 117 may utilize applications, services, sensors, etc. to collect such information. Further, the context information can be any one of multiple types of information that can provide conditions that a user may use to specify context-based coupon sharing. Context information may include, for instance, location information, camera information, microphone information, environmental sensor information, weather information, user calendar information, accelerometer information, compass information, body temperature information, etc. In one embodiment, the data collection module 117 may have connectivity to a location determination sensor system, such as a Global Positioning System (GPS) to access GPS satellites 119 to determine context information (e.g., the location of the UE 101). The UE 101 may then cause transmission of the collected information (e.g., the profile information, discount use history, preferences, context information, etc.) to the coupon sharing platform 103 for processing to facilitate context-based coupon sharing. In one embodiment, the coupon sharing platform 103 can receive and store the information in a user profile associated with the user in the user database 109. In certain embodiments, the user profile may include an identifier of the user (e.g., a username) and/or an identifier of the UE 101 (e.g., a hardware identifier such as an International Mobile Equipment Identity (IMEI), a phone number, an Internet Protocol address, etc.).

In one embodiment, each UE 101a-101n in the system 100 may transmit context information associated with the user of each respective UE 101a-101n to the coupon sharing platform 103. An application 113 (e.g., a coupon sharing application) executing on one of the UEs 101 associated with a user can then utilize the information stored on the coupon sharing platform 103 to initiate context-based coupon sharing. The application 109 can receive an input specifying one or more criteria (e.g., attribute-condition pairs) to determine a context-based group from among a plurality of UEs 101 for coupon sharing. This information can be transmitted via a communication network 105 to the coupon sharing platform 103. The coupon sharing platform 103 receives the input and may associate the input as a request to initiate coupon sharing. The criteria can include one or more context attributes associated with UEs 101 along with one or more optional relationship parameters or conditions.

In certain embodiments, a context attribute is a type of user context or coupon characteristic. Examples include location, time, calendar information, accelerometer information, compass information, body temperature information, outside weather information, etc. Further, relationships may include relationships to one or more context attributes of the UE 101a and/or fixed parameters. In one example, the input can include criteria specifying that the user wishes to share coupon information with one or more users selected based on the attribute-condition pairs related to the coupon and/or the context data of the users (e.g., share coupon information with one or more users who are within a particular distance). In another example, the input can include criteria specifying that the user wishes to initiate context-based coupon sharing with users in a particular region (e.g., a particular distance from the user's home, in a particular area such as a park, etc.). Moreover, in another example, the criteria can include sharing based on whether other users are to be located within vicinity of the user of the UE 101a within some period of time.

When the coupon sharing platform 103 receives a request to initiate context-based coupon sharing, the coupon sharing platform 103 queries the user database 109 for context information associated with users who may potentially participate in the coupon sharing. In certain embodiments, the coupon sharing platform 103 queries every user of the coupon sharing platform 103 for context information. In other embodiments, the query is bounded by relationships to the user. For example, the query can be limited to people that the user has as contacts on the user's UE 101a or within a particular social network, social graph, etc. In another example, the query can be limited based on other rules, such as whether the people have something in common with the user (e.g., same college, same city, same employer, etc.). After the coupon sharing platform 103 retrieves the context information from the user of the UE 101a and the other people using UEs 101, the coupon sharing platform 103 can perform context-based matching to evaluate specified attribute-conditions for initiating coupon-based sharing. In one embodiment, the coupon sharing platform 103 may evaluate the context information to infer higher level context information (e.g., activity, user behavior, interests, etc.) for use in context-based coupon sharing.

In one embodiment, at least some of the information in the user database 109 can be continuously changing, thus, once the coupon sharing request is received, the context processing platform 103 continuously or periodically updates the context information associated with participating users. In one embodiment, the context information may be divided into static or relatively static information (e.g., name, gender, address, etc.) and dynamic information (e.g., location, activity, etc.). In this way, the coupon sharing platform 109 can cache the static information and then expend resources only for updating the dynamic portion of the context information.

In one example, the user specifies criteria for coupon sharing based on whether the participating users are in a particular region (e.g., a particular park). For example, the participating users can upload location information to the coupon sharing platform 103. If the coupon sharing platform 103 determines that the other users are within the particular park, then the platform 103 can notify the users of a context match and request confirmation to initiate coupon sharing. In one embodiment, the coupon sharing platform 103 can also recommend that the users meet in the particular region (e.g., the park) to physically exchange the shared coupons.

In one embodiment, received criteria (e.g., attribute-condition pairs) associated with the coupon information and/or templates can be used to determine which users should receive coupon sharing notifications (e.g., which a context-based match is found for coupon sharing). The criteria can include one or more parameters or rules about or for processing the coupon information and/or user information (e.g., context information, preferences, etc.) associated with the users. In another example, the user may be associated one or more social networks on one or more social networking platforms 121 for sharing of coupons or coupon information. For example, the user may restrict coupon sharing activities to related members of the same social networking group. Examples of social networking services include networks in which users can interact with other users. In certain examples, user may update profiles to interact and share coupon information with others. Information associated with the social networking platform 121 may be utilized as criteria for determining and/or filtering coupons and/or the users who are participating in coupon sharing. In certain embodiments, the coupon sharing platform 103 can contact the social networking platform 121 (e.g., via an application programming interface) to retrieve social networking information utilized as criteria parameters for context-based coupon sharing.

Moreover, the participating users can set criteria that can be stored in the user profiles. As previously noted, such criteria can include selected relevant categories of coupons for sharing and/or the users engaged in the sharing. Further, the criteria can include subscription information about proximity of the subscription user to the shared coupons, promotions, discounts, etc. For example, the subscription user can set a user profile parameter so that the user only gets notifications of coupon sharing information if defined criteria are met.

In one embodiment, the group of users participating in coupon sharing can be stored in a phonebook or contact list of the user's device. For example, the coupon-sharing group can be a group (e.g., a context-based group or a context group) based on the context attributes of users. Moreover, potential contacts whose current context satisfies the specified criteria associated with a context-based group can automatically become a current member of the context-based group. In yet another embodiment, the system 100 can update the context-based group continuously (e.g., in real-time) so that the context-based group remains dynamic and up-to-date in the phonebook or contact list of the user's device to enable coupon sharing. The user can then invoke different communication services (e.g., phone calls, messaging, etc.) over the context-based group to initiate context-based coupon sharing.

Users may have the ability to specify whether or not the user would like to be invited to participate in coupon sharing. Further, under certain circumstances, the users can set privacy parameters with respect to visibility of all or a portion of the user's context data. Additionally, with respect to privacy, the context processing platform 103 can limit certain context information based on user profiles. As such, the users may determine what information the user wishes to share with whom, for example, by only allowing people with particular information (e.g., know the user's phone number and name, is a contact of the user, etc.) about the user to access the context information. Additionally, different context attributes can be set to different privacy parameters. For example, a location of the user can only be seen by contacts labeled as friends.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101 and coupon sharing platform 103 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the coupon sharing platform 103 may interact according to a client-server model with the applications 113 of the UE 101. According to the client-server model, a client process sends a message including a request to a server process, and the server process responds by providing a service (e.g., context-based grouping, social networking, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

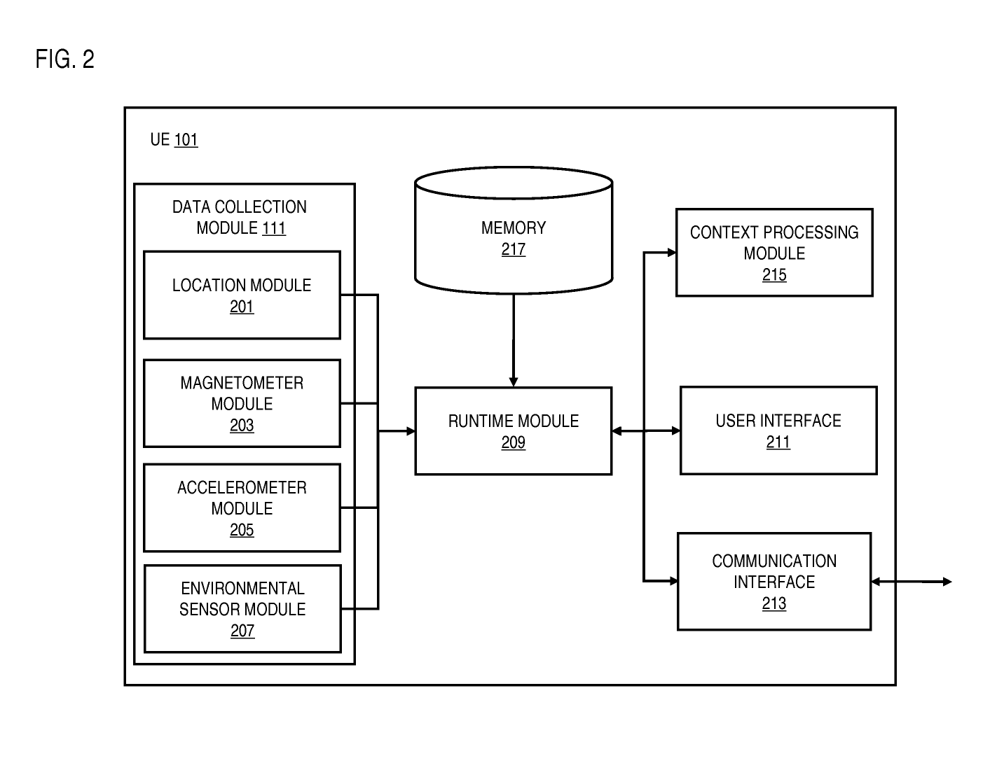

FIG. 2 is a diagram of the components of user equipment, according to one embodiment. By way of example, a UE 101 includes one or more components for context-based coupon sharing. It is contemplated that the functions of these components may be combined in one or more components or performed by other components of equivalent functionality. In this embodiment, the UE 101 includes a data collection module 111 that may include one or more location modules 201, magnetometer modules 203, accelerometer modules 205, environmental sensor modules 207, the UE 101 can also include a runtime module 209 to coordinate the use of other components of the UE 101, a user interface 211, a communication interface 213, a context processing module 215, and memory 217. An application 113 (e.g., a coupon sharing application) of the UE 101 can execute on the runtime module 209 utilizing the components of the UE 101.

The location module 201 can determine a user's location. The user's location can be determined by a triangulation system such as GPS, assisted GPS (A-GPS), Cell of Origin, or other location extrapolation technologies. Standard GPS and A-GPS systems can use satellites 113 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 217 and are transmitted to the context processing platform 103 via the communication interface. Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 217 and/or transmitted via the communication interface 213 to the context processing platform 103.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In one embodiment, vertical directional data obtained from an accelerometer is embedded into the metadata of captured or streaming media or otherwise associated with the UE 101 by the location services application 109. In certain embodiments, the magnetometer module 203 and accelerometer module 205 can be means for ascertaining a perspective of a user. This perspective information may be stored in the memory 217 and sent to the context processing platform 103.

Moreover, the environmental sensor module 207 can determine atmospheric conditions surrounding the UE 101. Such atmospheric conditions may include humidity, temperature, body temperature of the user, other biometric data of the user, etc. Once again, this information can be stored in the memory 217 and sent to the context processing platform 103. In certain embodiments, information collected from the data collection module 111 can be retrieved by the runtime module 209 and stored in memory 217. Then periodically, the information can be transmitted to the context processing platform 103.

In one embodiment, the communication interface 213 can be used to communicate with the coupon sharing platform 103 or other UEs 101. Certain communications can be via methods such as an internet protocol, messaging (e.g., SMS, MMS, etc.), or any other communication method (e.g., via the communication network 105). In some examples, the UE 101 can send context information associated with the UE 101 to the coupon sharing platform 103. In other examples, the user can utilize a user interface 211 to generate a request for contributing and/or receiving coupon information based on context to send to the coupon sharing platform 103.

The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc. In certain embodiments, the user interface 211 and/or runtime module 209 can be means for causing presentation of context-based coupon sharing results.

The context processing module 215 may be utilized in determining context information from the data collection module 111 and/or applications 109 executing on the runtime module 209. This information may be caused to be transmitted, via the communication interface 213 to the context processing platform 103. The context processing module 215 may additionally be utilized as a means for determining groups based on input criteria and received context information associated with other UEs 101. In certain embodiments, the context processing module 215 can infer higher level context information from the context data such as favorite locations, significant places, common activities, etc.

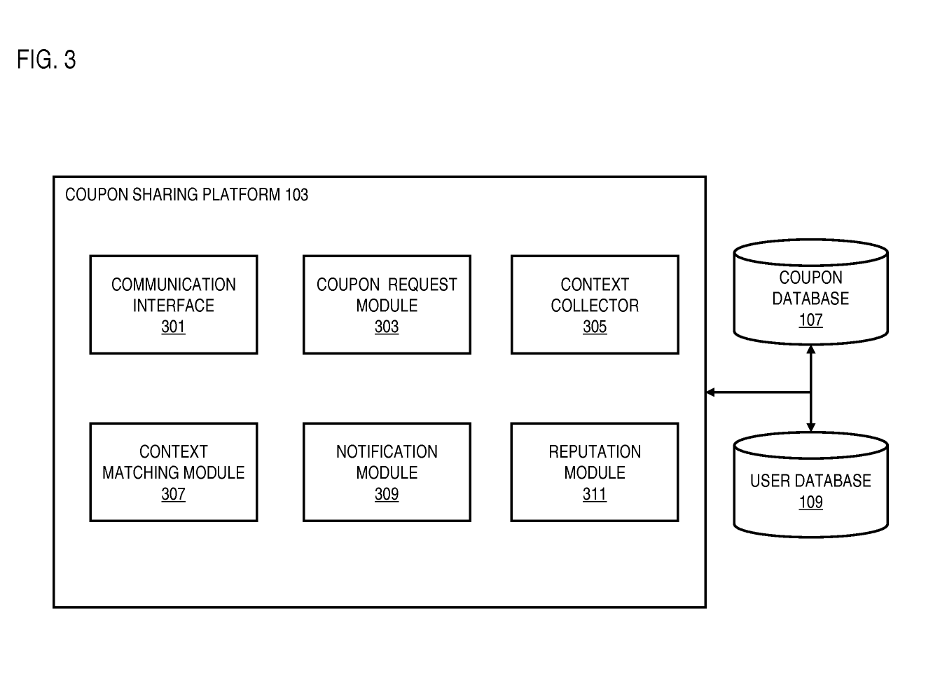

FIG. 3 is a diagram of the components of a coupon sharing platform, according to one embodiment. By way of example, the coupon sharing platform 103 includes one or more components for providing context-based coupon sharing. It is contemplated that the functions of these components may be combined in one or more components or performed by other components of equivalent functionality (e.g., the discount module 215). In this embodiment, the discount management platform 103 includes a communication interface 301, a coupon request module 303, a context collector 305, a context matching module 307, a notification module 309, and a reputation module 311. It is contemplated that all or a portion of the functions of the discount management platform 103 may be performed by the application 113 of the UE 101.

In one embodiment, the communication interface 301 can be used to communicate with a UE 101 as well as other devices connected on the communication network 105. In one embodiment, the coupon sharing platform 103 can requests for contributing or sharing coupon information, user context information, user-specified templates, user profile information, and the like from the UE 101 via the communication interface 301 via methods such as internet protocol, MMS, SMS, GPRS, or any other available communication method. By way of example, the UE 101 may further send coupon sharing requests, context-based matching results, coupon information, discounts, and related information to the coupon sharing platform 103 to access context-based coupon sharing functions, such as to determine available coupons, determine participating users, update user profiles, update context data, etc. in the user database 109 and/or the coupon database 107.

In one embodiment, the coupon request module 303 may receive requests to contribute (e.g., publish coupon information in a publish-subscribe environment) and/or request (e.g., subscribe to coupon information) coupons or coupon information from one or more participating users. In one embodiment, the requests may include one or more criteria for defining the coupon to be shared or requested. In one embodiment, the criteria are context-based. As noted previously, the criteria can be provided in template form and can be converted to into structure attribute-condition pairs. More specifically, the coupon request module 303 splits both coupon contribution and requests and their associated criteria in attributes (e.g., a coupon's category, a user's gender) and conditions (e.g., location of sharing should be around the user's home, discount should be more than 15%). In another embodiment, the coupon request module 303 can also split the attribute-condition pairs into static (e.g., category, gender, discount, etc.) and dynamic (e.g., location, activity, etc.). As used herein, static refers to attribute-conditions that do not change or do not change very often, and dynamic refers to attribute-conditions that change often.

In one embodiment, the context collector 305 can receive, determine, and/or monitor context information associated with participating users or their respective UEs 101 via the communication network 105. The context collector 501 can poll for updates to the context information and/or be pushed the information when a change occurs on a UE 101. The context collector 501 can further store the context information in a user database 109. The context information can be stored in or tied with a profile associated with each individual UE 101 and/or user of the UE 101.

On obtaining the context information, the context matching module 307 independently (and thus in parallel) evaluates each attribute-condition pair with respect to the collected context data. The context matching module 307 then combines the results of its evaluation of all attribute-condition pairs to determine whether there is a context-based sufficient to initiate the coupon sharing process. In one embodiment, the evaluation of static attribute-condition pairs can be performed once and the result can be cached. If the static attribute-condition pair changes, the related contribution and/or request can be renewed or reevaluated. For dynamic attribute-condition pairs, their results are evaluated each time the context changes.

On determining a match, the context matching module 307 may also generate one or more recommendations for how the coupon sharing or exchange is to take place. For example, if the coupon is an electronic coupon, the coupon request module 303 may receive and store the electronic coupon as part of the request. In this way, on context matching module 307 can recommend electronic delivery of the electronic coupon and need not arrange for physical delivery. On the other hand, if the coupon is a physical coupon, the context matching module 307 can recommend a mode (e.g., means of delivery), a location, and/or a time for physical delivery. In one embodiment, the recommendation may include interfacing with a mapping or navigation application to direct the users to the delivery location.

Also on determining a match, the notification module 309 can generate an alert or notification of the match to participating users (e.g., users who have requested to receive such coupon information). In one embodiment, the notification module 309 may evaluate the user's user profile, context information, etc. to determine whether to present the notification. For example, the user may prefer to be notified only when the user is at home and not at work, or only during certain hours.

On completing the sharing of the coupon information, the ratings of the contributor and the requestor can be evaluated and/or rated by the reputation module 311 to give a reputation rating. In certain embodiments, the reputation module 311 may also determine an experience rating to describe how many coupon sharing transactions the user has participated in. In other embodiments, the experience rating and the reputation rating may be combined on in metric.

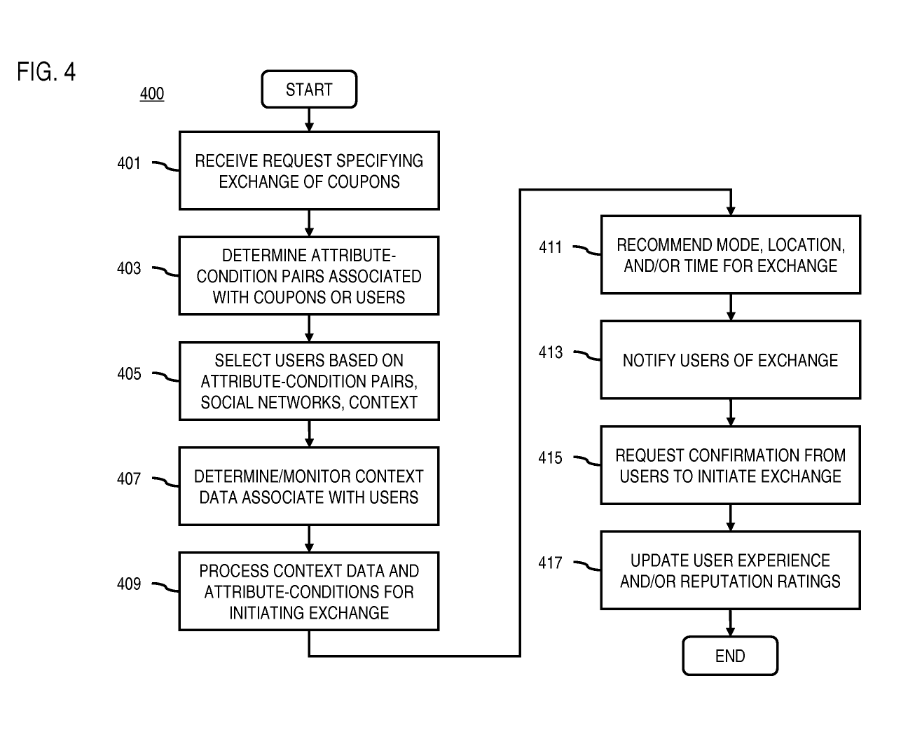

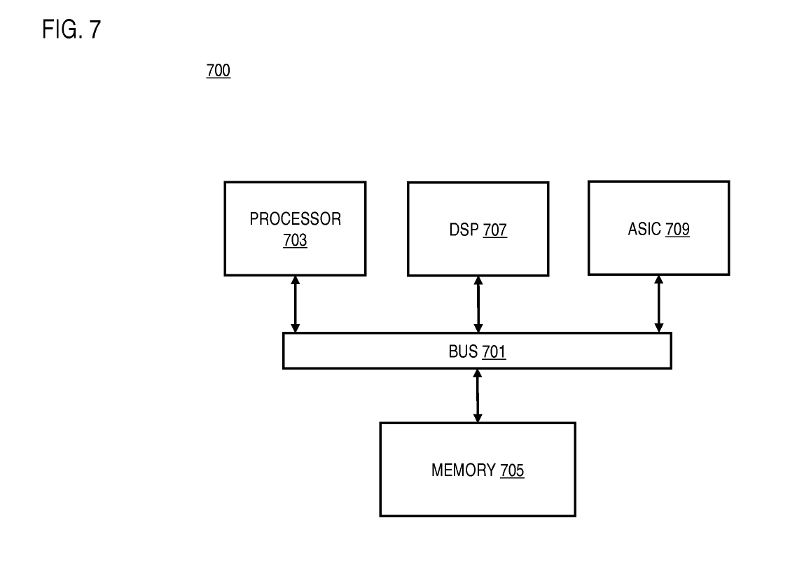

FIG. 4 is a flowchart of a process for context-based coupon sharing, according to one embodiment. In one embodiment, the coupon sharing platform 103 and/or an application 113 of the UE 101 performs the process 400 and is implemented in, for instance, a chip set including a processor and a memory as shown in FIG. 7. As such, the coupon sharing platform 103 and/or application 113 can provide means for accomplishing various parts of the process 400 as well as means for accomplishing other processes in conjunction with other components of the system 100. Throughout this process, the coupon sharing platform 103 is referred to as completing various portions of the process 400, however it is understood that the UE 101 can perform some of and/or all of the process steps.

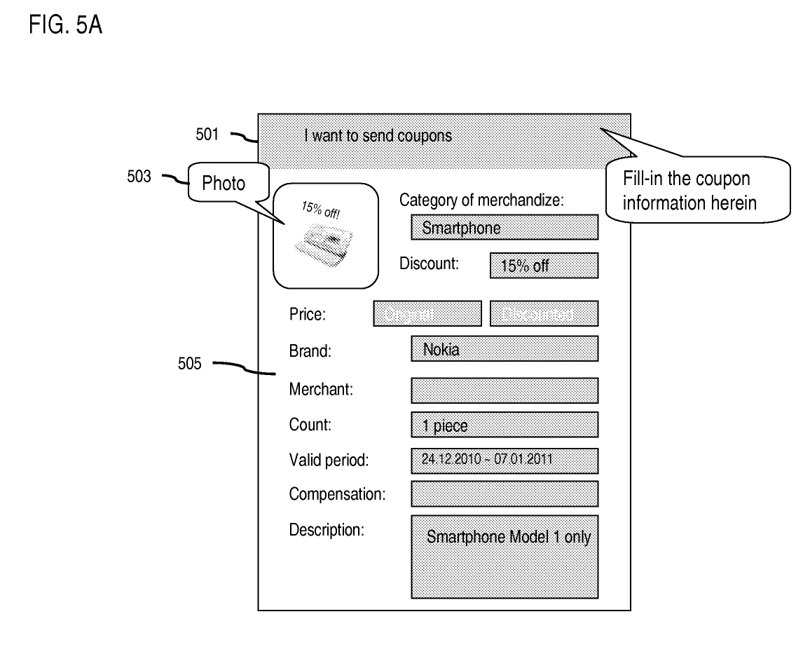

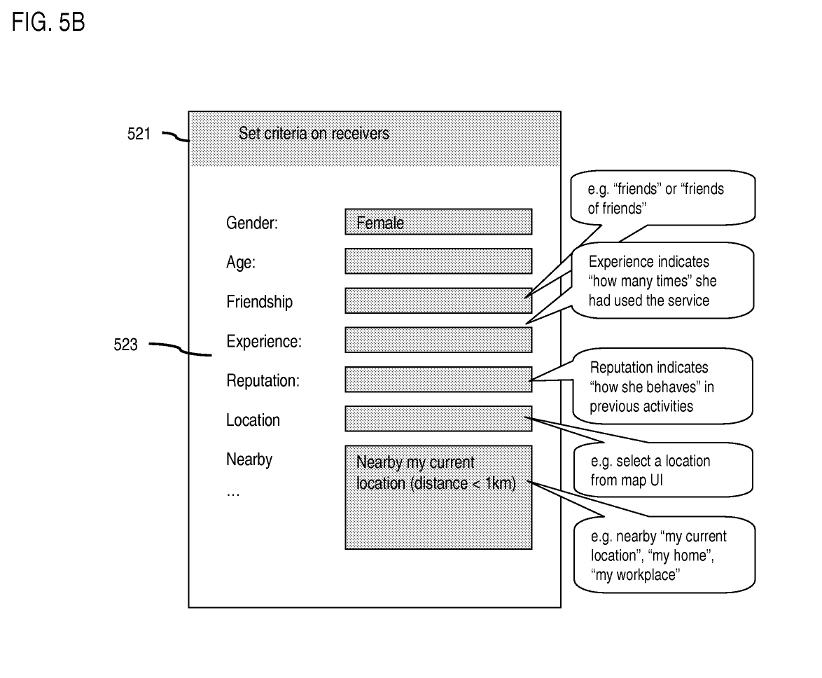

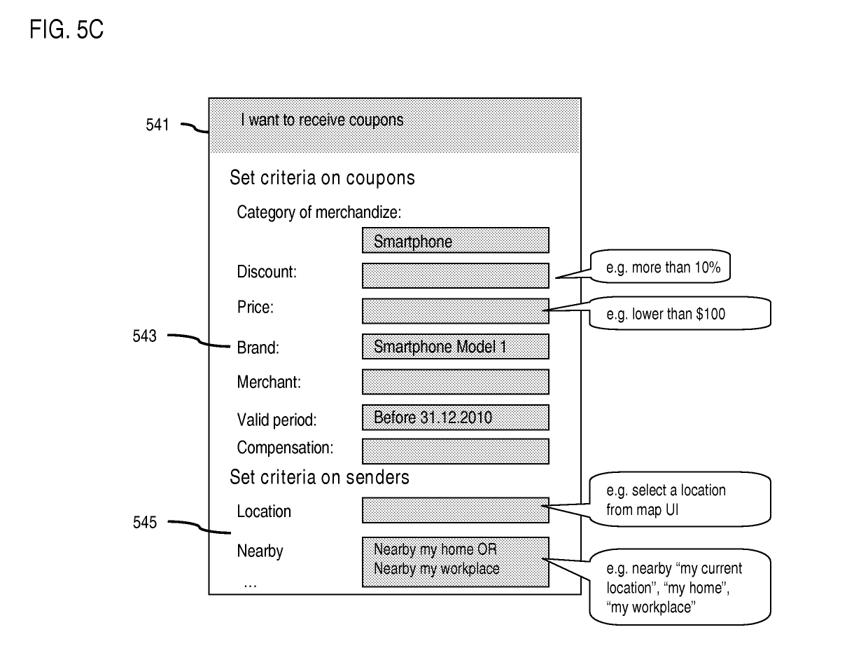

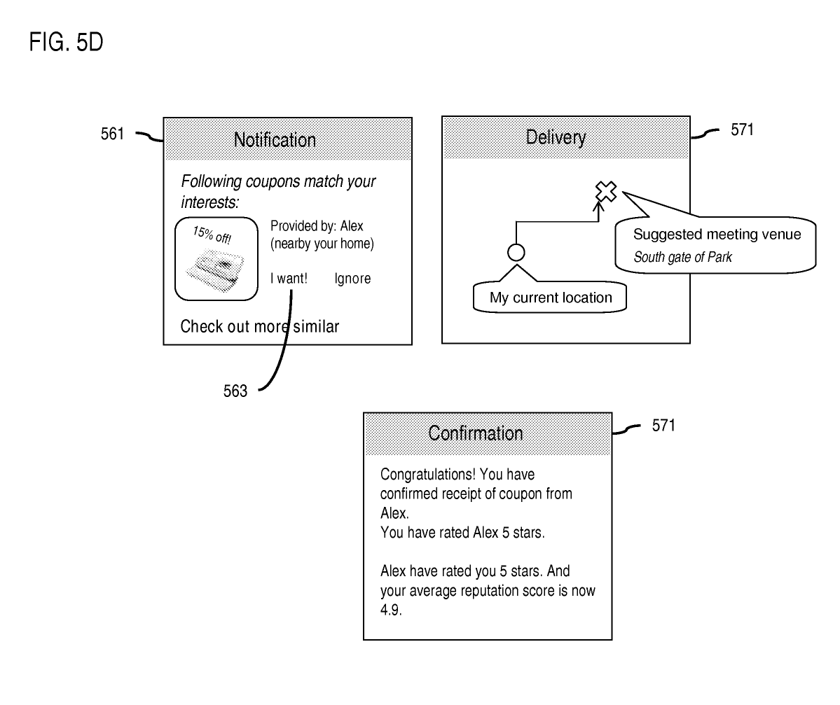

In step 401, the coupon sharing platform 103 receives a request specifying an exchange of one or more coupons, the request including, at least in part, one or more attribute-condition pairs associated with the one or more coupons, one or more participants of the exchange, or a combination thereof. The input can be received from the UE 101a, which would like to contribute and/or request coupon information for sharing. The input may be specified as further described in FIGS. 5A-5D. In certain embodiments, the UE 101a receives the input from a user interface. In one embodiment, both contributors and requestors can browse existing coupon contributions and/or requests or just wait for automatic notifications. Moreover, the user can search coupons by category or merchandise, merchant, validity period, etc. In some cases, the coupon sender may decide to approve or decline each request, even when a user satisfies the conditions for receiving the coupon. The coupon sharing platform 103 can then determine the attribute-condition pairs based, at least in part, on the one or more coupons and/or characteristics of the participating users (step 403).

Next, the coupon sharing platform 103 causes, at least in part, a selection of the participating users based, at least in part, on the one or more attribute-condition pairs, the context data, or a combination thereof (step 405). In one embodiment, the coupon sharing platform 103 determines at least one social network, at least one social graph, or a combination thereof associated with one or more of the participating users, and then selects the participating users based, at least in part, on the social network, social graph, attribute-condition pairs, context data, etc.

In step 407, the coupon sharing platform 103 determines and/or monitors context data associated with the participating users and/or their devices (e.g., the UEs 101). In embodiment, the monitoring of the context data is used for comparison or evaluation of the attribute-condition pairs against the context data. As previously noted, the coupon sharing platform 103 receives updates of context information from the other UEs 101 as well as the UE 101a. The context information (e.g., location, calendar information, sensor information, etc.) can be collected at each of the UEs 101 and be transmitted to the coupon sharing platform 103. The other UEs 101 can be selected in various manners (as described above). In one embodiment, the other UEs 101 can be contacts in a phonebook associated with the UE 101a. In another embodiment, the other UEs 101 can be otherwise associated with the UE 101a (e.g., a member of the same group) or be part of a public or social network community. In one embodiment, the context data includes, at least in part, experience data, reputation data, or a combination thereof based, at least in part, on one or more previously completely exchanges.

To protect privacy, the user may take one of several steps including: (1) the user may adjust parameters in the request criteria to better protect privacy, e.g., “not further than 1 km from my home” is better than “not further than 10 m from my home”; and (2) the user can also protect privacy by sacrificing some sharing changes, e.g., a user A contributes a coupon with a criteria of “only send to females”, user B is notified of this coupon, but user B chooses not to apply for the coupon because user B is not willing to disclose gender information to user A.

The coupon sharing platform 103 then causes, at least in part, processing of the one or more attribute-condition pairs, the context data, or a combination thereof for initiating the exchange between the participating users (step 409). In one embodiment, the coupon sharing platform 103 determines one or more preferences (e.g., favorite items, categories, etc.) associated with the participating users. The processing of the one or more attribute-condition pairs, the context data, or a combination thereof is further based, at least in part, on the one or more preferences. In another embodiment, the coupon sharing platform 103 also determines at least one privacy setting, at least one security setting, or a combination thereof associated with the context data, wherein the processing of the one or more attribute-condition pairs, the context data, or a combination thereof is further based, at least in part, on the at least one privacy setting, the at least one security setting, or a combination thereof.

At step 411, the coupon sharing platform 103 causes, at least in part, processing of the one or more attribute-condition pairs, the context data, or a combination thereof for generating one or more recommendations for a mode, a location, a time, or a combination thereof associated with the exchange. On determining a match and/or generation of the recommendations, the coupon sharing platform 103 determines to cause, at least in part, generation of a notification with respect to the exchange and to cause, at least in part, transmission of the notification to the participating users (step 413).

At step 415, the coupon sharing platform 103 receives an input from the first user, the at least one second user, or a combination thereof for specifying at least one confirmation to initiate the exchange and then causing, at least in part, processing of the input to initiate the exchange. The coupon sharing platform 103 then updates the user experience and/or reputation ratings of the participating users.

FIGS. 5A-5D are diagrams of user interfaces utilized in the processes of FIGS. 3-4, according to various embodiments. FIG. 5A depicts a user interface (UI) 501 that presents a template for contributing coupon information for sharing. In this example, a contributing user has a coupon that can be exchanged for 15% when buying a Smartphone Model 1 during the Christmas season. However, the contributing user does not plan to use the coupon before the coupon expires and wants to share the coupon through the coupon sharing service of the platform 103. The contributing user fills in the template of the UI 501 to specify attributes of the smartphone including, for instance, a photo 503 and other attribute fields 505.

In one embodiment, as shown in FIG. 5B, the contributing user may also use a template of the UI 521 to specify attribute-condition pairs for potential receivers of the coupon. The contributing user may optionally select to fill in any one or more of the attribute fields 523 (e.g., gender, age, friendship, experience, reputation, and location). In this case, the contributing user specifies that the receiving user must be a female within less than 1 km from the contributing user's current location.

FIG. 5C depicts a UI 541 for requesting users to specify the types of coupons they would like to receive. As shown, the UI 541 includes a template for setting criteria 543 related to the desired coupon and another set of criteria 545 related to attribute of contributing users. In this example, the requesting user has specified in the coupon criteria 543 section that he or she is looking for coupon valid through at least Dec. 31, 2010 and that the sender or contributor should be near the requesting user's home or workplace. The requesting user submits the request to the coupon sharing platform 103 for processing.

In response, the coupon sharing platform 103 performs a real-time context-based matching of the requested coupons against available coupons, which results in presentation of the notification 561. As shown, the notification 561 includes a description of the matching coupon and requests confirmation from the requesting user to confirm the proposed coupon sharing. In this example, the requesting user clicks on the option 563 to confirm that the user wants the coupon. Accordingly, the discount management platform 103 presents UI 571 depicting a map of the recommended meeting place to physically transfer the coupon. On successful completion of the transfer, the coupon sharing platform 103 presents a confirmation UI 571 that presents user experience ratings associated with the coupon sharing transaction.

The processes described herein for providing context-based coupon sharing may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

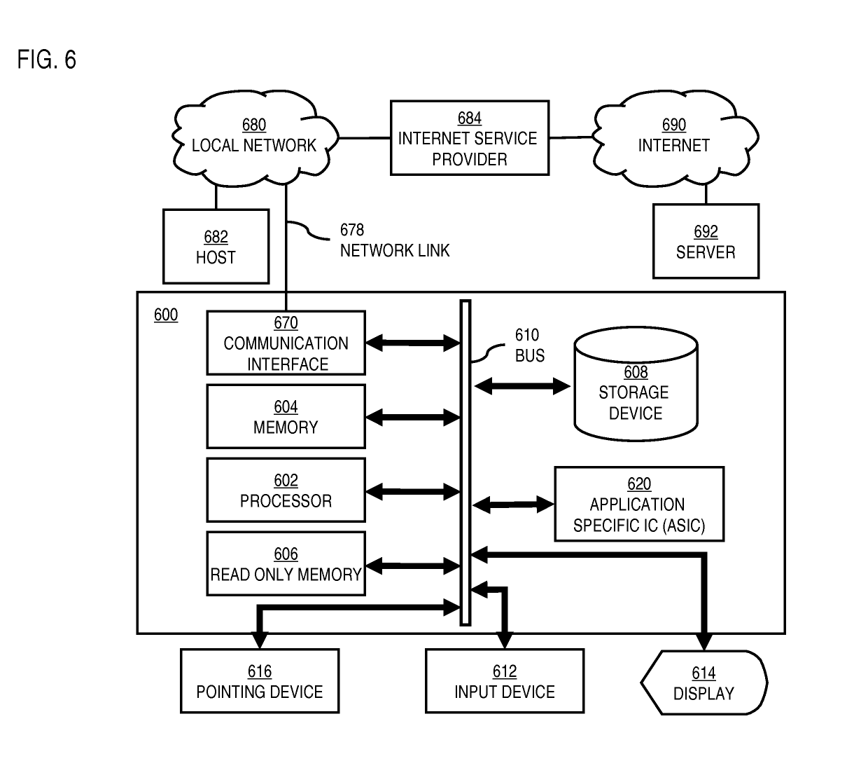

FIG. 6 illustrates a computer system 600 upon which an embodiment of the invention may be implemented. Although computer system 600 is depicted with respect to a particular device or equipment, it is contemplated that other devices or equipment (e.g., network elements, servers, etc.) within FIG. 6 can deploy the illustrated hardware and components of system 600. Computer system 600 is programmed (e.g., via computer program code or instructions) to provide context-based coupon sharing as described herein and includes a communication mechanism such as a bus 610 for passing information between other internal and external components of the computer system 600. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 600, or a portion thereof, constitutes a means for performing one or more steps of providing context-based coupon sharing.

A bus 610 includes one or more parallel conductors of information so that information is transferred quickly among devices coupled to the bus 610. One or more processors 602 for processing information are coupled with the bus 610.

A processor (or multiple processors) 602 performs a set of operations on information as specified by computer program code related to providing context-based coupon sharing. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 610 and placing information on the bus 610. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 602, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 600 also includes a memory 604 coupled to bus 610. The memory 604, such as a random access memory (RAM) or any other dynamic storage device, stores information including processor instructions for providing context-based coupon sharing. Dynamic memory allows information stored therein to be changed by the computer system 600. RAM allows a unit of information stored at a location called a memory address to be stored and retrieved independently of information at neighboring addresses. The memory 604 is also used by the processor 602 to store temporary values during execution of processor instructions. The computer system 600 also includes a read only memory (ROM) 606 or any other static storage device coupled to the bus 610 for storing static information, including instructions, that is not changed by the computer system 600. Some memory is composed of volatile storage that loses the information stored thereon when power is lost. Also coupled to bus 610 is a non-volatile (persistent) storage device 608, such as a magnetic disk, optical disk or flash card, for storing information, including instructions, that persists even when the computer system 600 is turned off or otherwise loses power.

Information, including instructions for providing context-based coupon sharing, is provided to the bus 610 for use by the processor from an external input device 612, such as a keyboard containing alphanumeric keys operated by a human user, or a sensor. A sensor detects conditions in its vicinity and transforms those detections into physical expression compatible with the measurable phenomenon used to represent information in computer system 600. Other external devices coupled to bus 610, used primarily for interacting with humans, include a display device 614, such as a cathode ray tube (CRT), a liquid crystal display (LCD), a light emitting diode (LED) display, an organic LED (OLED) display, a plasma screen, or a printer for presenting text or images, and a pointing device 616, such as a mouse, a trackball, cursor direction keys, or a motion sensor, for controlling a position of a small cursor image presented on the display 614 and issuing commands associated with graphical elements presented on the display 614. In some embodiments, for example, in embodiments in which the computer system 600 performs all functions automatically without human input, one or more of external input device 612, display device 614 and pointing device 616 is omitted.

In the illustrated embodiment, special purpose hardware, such as an application specific integrated circuit (ASIC) 620, is coupled to bus 610. The special purpose hardware is configured to perform operations not performed by processor 602 quickly enough for special purposes. Examples of ASICs include graphics accelerator cards for generating images for display 614, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 600 also includes one or more instances of a communications interface 670 coupled to bus 610. Communication interface 670 provides a one-way or two-way communication coupling to a variety of external devices that operate with their own processors, such as printers, scanners and external disks. In general the coupling is with a network link 678 that is connected to a local network 680 to which a variety of external devices with their own processors are connected. For example, communication interface 670 may be a parallel port or a serial port or a universal serial bus (USB) port on a personal computer. In some embodiments, communications interface 670 is an integrated services digital network (ISDN) card or a digital subscriber line (DSL) card or a telephone modem that provides an information communication connection to a corresponding type of telephone line. In some embodiments, a communication interface 670 is a cable modem that converts signals on bus 610 into signals for a communication connection over a coaxial cable or into optical signals for a communication connection over a fiber optic cable. As another example, communications interface 670 may be a local area network (LAN) card to provide a data communication connection to a compatible LAN, such as Ethernet. Wireless links may also be implemented. For wireless links, the communications interface 670 sends or receives or both sends and receives electrical, acoustic or electromagnetic signals, including infrared and optical signals, that carry information streams, such as digital data. For example, in wireless handheld devices, such as mobile telephones like cell phones, the communications interface 670 includes a radio band electromagnetic transmitter and receiver called a radio transceiver. In certain embodiments, the communications interface 670 enables connection to the communication network 105 for providing context-based coupon sharing to the UE 101.

The term “computer-readable medium” as used herein refers to any medium that participates in providing information to processor 602, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 608. Volatile media include, for example, dynamic memory 604. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 620.

Network link 678 typically provides information communication using transmission media through one or more networks to other devices that use or process the information. For example, network link 678 may provide a connection through local network 680 to a host computer 682 or to equipment 684 operated by an Internet Service Provider (ISP). ISP equipment 684 in turn provides data communication services through the public, world-wide packet-switching communication network of networks now commonly referred to as the Internet 690.

A computer called a server host 692 connected to the Internet hosts a process that provides a service in response to information received over the Internet. For example, server host 692 hosts a process that provides information representing video data for presentation at display 614. It is contemplated that the components of system 600 can be deployed in various configurations within other computer systems, e.g., host 682 and server 692.

At least some embodiments of the invention are related to the use of computer system 600 for implementing some or all of the techniques described herein. According to one embodiment of the invention, those techniques are performed by computer system 600 in response to processor 602 executing one or more sequences of one or more processor instructions contained in memory 604. Such instructions, also called computer instructions, software and program code, may be read into memory 604 from another computer-readable medium such as storage device 608 or network link 678. Execution of the sequences of instructions contained in memory 604 causes processor 602 to perform one or more of the method steps described herein. In alternative embodiments, hardware, such as ASIC 620, may be used in place of or in combination with software to implement the invention. Thus, embodiments of the invention are not limited to any specific combination of hardware and software, unless otherwise explicitly stated herein.

The signals transmitted over network link 678 and other networks through communications interface 670, carry information to and from computer system 600. Computer system 600 can send and receive information, including program code, through the networks 680, 690 among others, through network link 678 and communications interface 670. In an example using the Internet 690, a server host 692 transmits program code for a particular application, requested by a message sent from computer 600, through Internet 690, ISP equipment 684, local network 680 and communications interface 670. The received code may be executed by processor 602 as it is received, or may be stored in memory 604 or in storage device 608 or any other non-volatile storage for later execution, or both. In this manner, computer system 600 may obtain application program code in the form of signals on a carrier wave.

Various forms of computer readable media may be involved in carrying one or more sequence of instructions or data or both to processor 602 for execution. For example, instructions and data may initially be carried on a magnetic disk of a remote computer such as host 682. The remote computer loads the instructions and data into its dynamic memory and sends the instructions and data over a telephone line using a modem. A modem local to the computer system 600 receives the instructions and data on a telephone line and uses an infra-red transmitter to convert the instructions and data to a signal on an infra-red carrier wave serving as the network link 678. An infrared detector serving as communications interface 670 receives the instructions and data carried in the infrared signal and places information representing the instructions and data onto bus 610. Bus 610 carries the information to memory 604 from which processor 602 retrieves and executes the instructions using some of the data sent with the instructions. The instructions and data received in memory 604 may optionally be stored on storage device 608, either before or after execution by the processor 602.

FIG. 7 illustrates a chip set or chip 700 upon which an embodiment of the invention may be implemented. Chip set 700 is programmed to provide context-based coupon sharing as described herein and includes, for instance, the processor and memory components described with respect to FIG. 6 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 700 can be implemented in a single chip. It is further contemplated that in certain embodiments the chip set or chip 700 can be implemented as a single “system on a chip.” It is further contemplated that in certain embodiments a separate ASIC would not be used, for example, and that all relevant functions as disclosed herein would be performed by a processor or processors. Chip set or chip 700, or a portion thereof, constitutes a means for performing one or more steps of providing user interface navigation information associated with the availability of functions. Chip set or chip 700, or a portion thereof, constitutes a means for performing one or more steps of providing context-based coupon sharing.

In one embodiment, the chip set or chip 700 includes a communication mechanism such as a bus 701 for passing information among the components of the chip set 700. A processor 703 has connectivity to the bus 701 to execute instructions and process information stored in, for example, a memory 705. The processor 703 may include one or more processing cores with each core configured to perform independently. A multi-core processor enables multiprocessing within a single physical package. Examples of a multi-core processor include two, four, eight, or greater numbers of processing cores. Alternatively or in addition, the processor 703 may include one or more microprocessors configured in tandem via the bus 701 to enable independent execution of instructions, pipelining, and multithreading. The processor 703 may also be accompanied with one or more specialized components to perform certain processing functions and tasks such as one or more digital signal processors (DSP) 707, or one or more application-specific integrated circuits (ASIC) 709. A DSP 707 typically is configured to process real-world signals (e.g., sound) in real time independently of the processor 703. Similarly, an ASIC 709 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 700 includes merely one or more processors and some software and/or firmware supporting and/or relating to and/or for the one or more processors.

The processor 703 and accompanying components have connectivity to the memory 705 via the bus 701. The memory 705 includes both dynamic memory (e.g., RAM, magnetic disk, writable optical disk, etc.) and static memory (e.g., ROM, CD-ROM, etc.) for storing executable instructions that when executed perform the inventive steps described herein to provide context-based coupon sharing. The memory 705 also stores the data associated with or generated by the execution of the inventive steps.

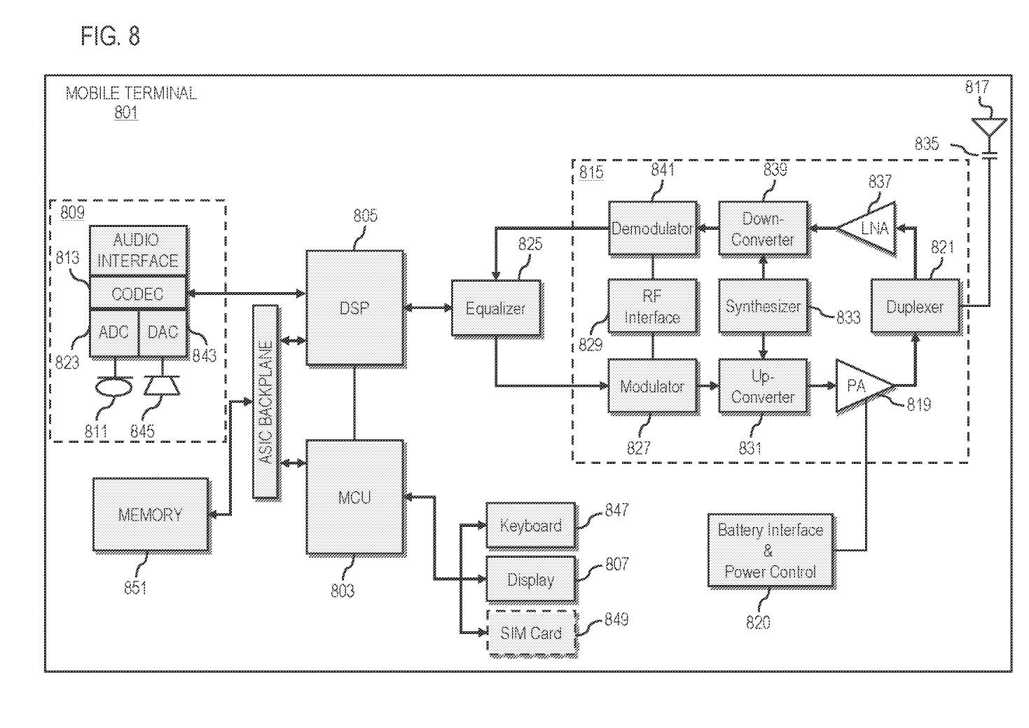

FIG. 8 is a diagram of exemplary components of a mobile terminal (e.g., handset) for communications, which is capable of operating in the system of FIG. 1, according to one embodiment. In some embodiments, mobile terminal 801, or a portion thereof, constitutes a means for performing one or more steps of providing context-based coupon sharing. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile terminal functions that perform or support the steps of providing context-based coupon sharing. The display 807 includes display circuitry configured to display at least a portion of a user interface of the mobile terminal (e.g., mobile telephone). Additionally, the display 807 and display circuitry are configured to facilitate user control of at least some functions of the mobile terminal. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system, via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile terminal 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 805. A Digital to Analog Converter (DAC) 843 converts the signal and the resulting output is transmitted to the user through the speaker 845, all under control of a Main Control Unit (MCU) 803 which can be implemented as a Central Processing Unit (CPU) (not shown).

The MCU 803 receives various signals including input signals from the keyboard 847. The keyboard 847 and/or the MCU 803 in combination with other user input components (e.g., the microphone 811) comprise a user interface circuitry for managing user input. The MCU 803 runs a user interface software to facilitate user control of at least some functions of the mobile terminal 801 to provide context-based coupon sharing. The MCU 803 also delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the terminal. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile terminal 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile terminal 801 on a radio network. The card 849 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-59. (canceled)

60. An apparatus comprising:
at least one processor; and
at least one memory including computer program code for one or more programs,
the at least one memory and the computer program code configured to, with the at least one processor, cause the apparatus to perform at least the following,
receive a request specifying an exchange of one or more coupons, the request including, at least in part, one or more attribute-condition pairs associated with the one or more coupons, one or more participants of the exchange, or a combination thereof;
determine context data associated with a first user, at least one device associated with the first user, at least one second user, at least one other device associated with the at least one second user, or a combination thereof; and
cause, at least in part, processing of the one or more attribute-condition pairs, the context data, or a combination thereof for initiating the exchange between the first user and the at least one second user.

61. An apparatus of claim 60, wherein the apparatus is further caused to:
cause, at least in part, processing of the one or more attribute-condition pairs, the context data, or a combination thereof for generating one or more recommendations for a mode, a location, a time, or a combination thereof associated with the exchange.

62. An apparatus of claim 60, wherein the apparatus is further caused to:
determine to cause, at least in part, generation of a notification with respect to the exchange; and
determine to cause, at least in part, transmission of the notification to the first user, the at least one device, the at least one second user, the at least one other device, or a combination thereof.

63. An apparatus of claim 60, wherein the apparatus is further caused to:
receive an input from the first user, the at least one second user, or a combination thereof for specifying at least one confirmation to initiate the exchange; and
cause, at least in part, processing of the input to initiate the exchange.

64. An apparatus of claim 60, wherein the apparatus is further caused to:
determine one or more preferences associated with the first user, the at least one second user, or a combination thereof,
wherein the processing of the one or more attribute-condition pairs, the context data, or a combination thereof is further based, at least in part, on the one or more preferences.

65. An apparatus of claim 60, wherein the apparatus is further caused to:
cause, at least in part, a selection of the at least one second user based, at least in part, on the one or more attribute-condition pairs, the context data, or a combination thereof.

66. An apparatus of claim 60, wherein the apparatus is further caused to:
cause, at least in part, monitoring of the context data against the one or more attribute-condition pairs; and
determine to initiate the exchange based, at least in part, on the monitoring.

67. An apparatus of claim 60, wherein the apparatus is further caused to:
determine at least one social network, at least one social graph, or a combination thereof associated with the first user; and
cause, at least in part, a selection of the at least one second user based, at least in part, on the social graph.

68. An apparatus of claim 60, wherein the apparatus is further caused to:
determine at least one privacy setting, at least one security setting, or a combination thereof associated with the context data,
wherein the processing of the one or more attribute-condition pairs, the context data, or a combination thereof is further based, at least in part, on the at least one privacy setting, the at least one security setting, or a combination thereof.

69. A method comprising:
receiving a request specifying an exchange of one or more coupons, the request including, at least in part, one or more attribute-condition pairs associated with the one or more coupons, one or more participants of the exchange, or a combination thereof;
determining context data associated with a first user, at least one device associated with the first user, at least one second user, at least one other device associated with the at least one second user, or a combination thereof; and
causing, at least in part, processing of the one or more attribute-condition pairs, the context data, or a combination thereof for initiating the exchange between the first user and the at least one second user.

70. A method of claim 69, further comprising:
causing, at least in part, processing of the one or more attribute-condition pairs, the context data, or a combination thereof for generating one or more recommendations for a mode, a location, a time, or a combination thereof associated with the exchange.

71. A method of claim 69, further comprising:
determining to cause, at least in part, generation of a notification with respect to the exchange; and
determining to cause, at least in part, transmission of the notification to the first user, the at least one device, the at least one second user, the at least one other device, or a combination thereof.

72. A method of claim 69, further comprising:
receiving an input from the first user, the at least one second user, or a combination thereof for specifying at least one confirmation to initiate the exchange; and
causing, at least in part, processing of the input to initiate the exchange.

73. A method of claim 69, further comprising:
determining one or more preferences associated with the first user, the at least one second user, or a combination thereof,
wherein the processing of the one or more attribute-condition pairs, the context data, or a combination thereof is further based, at least in part, on the one or more preferences.

74. A method of claim 69, further comprising:
causing, at least in part, a selection of the at least one second user based, at least in part, on the one or more attribute-condition pairs, the context data, or a combination thereof.

75. A method of claim 69, further comprising:
causing, at least in part, monitoring of the context data against the one or more attribute-condition pairs; and
determining to initiate the exchange based, at least in part, on the monitoring.

76. A method of claim 69, further comprising:
determining at least one social network, at least one social graph, or a combination thereof associated with the first user; and
causing, at least in part, a selection of the at least one second user based, at least in part, on the social graph.

77. A method of claim 69, further comprising:
determining at least one privacy setting, at least one security setting, or a combination thereof associated with the context data,
wherein the processing of the one or more attribute-condition pairs, the context data, or a combination thereof is further based, at least in part, on the at least one privacy setting, the at least one security setting, or a combination thereof.

78. A computer program product including one or more sequences of one or more instructions which, when executed by one or more processors, cause an apparatus to at least perform the steps:
receive a request specifying an exchange of one or more coupons, the request including, at least in part, one or more attribute-condition pairs associated with the one or more coupons, one or more participants of the exchange, or a combination thereof;
determine context data associated with a first user, at least one device associated with the first user, at least one second user, at least one other device associated with the at least one second user, or a combination thereof; and
cause, at least in part, processing of the one or more attribute-condition pairs, the context data, or a combination thereof for initiating the exchange between the first user and the at least one second user.

79. A computer program product of claim 78, further comprising:
causing, at least in part, processing of the one or more attribute-condition pairs, the context data, or a combination thereof for generating one or more recommendations for a mode, a location, a time, or a combination thereof associated with the exchange.
